(19) United States
(12) Patent Application Publication
(10) Pub. No.: US 2023/0219855 A1
(43) Pub. Date: Jul. 13, 2023

(54) METHOD OF PREPARATION OF CERAMIC SLURRY FOR USE IN 3D PRINTING AND METHOD OF PREPARATION OF CERAMIC PRODUCT

(71) Applicant: NATIONAL CHUNG SHAN INSTITUTE OF SCIENCE AND TECHNOLOGY, Taoyuan City (TW)

(72) Inventors: CHUN-TE WU, Taoyuan City (TW); YANG-KUAO KUO, Taoyuan City (TW)

(21) Appl. No.: 17/572,652

(22) Filed: Jan. 11, 2022

(51) Int. Cl. C04B 35/486; C04B 35/634; C04B 35/622; C04B 35/626; C04B 35/624; C04B 35/64; B33Y 40/10; B33Y 40/20; B28B 1/00; B28B 11/24

(52) U.S. Cl. CPC C04B 35/486; C04B 35/63416; C04B 35/63488; C04B 35/62218; C04B 35/6264; C04B 35/624; C04B 35/64; B33Y 40/10; B33Y 40/20; B28B 1/001; B28B 11/243; C04B 2235/3246; C04B 2235/6026; C04B 2235/658; C04B 2235/6562; C04B 2235/6567; B33Y 10/00

(57) ABSTRACT

A method of preparation of a ceramic slurry for use in 3D printing includes steps of: (A) providing a plasticizer and a disperser and mixing the plasticizer and the disperser evenly; (B) mixing the mixture obtained in step (A) with an adhesive, wherein the adhesive is polyvinyl alcohol; and (C) adding a Yttria-stabilized zirconia powder to the mixture obtained in step (B) to produce, by sufficient blending and deaerating, the ceramic slurry for use in 3D printing. A method of preparation of a ceramic product includes steps of: (A) preparing a ceramic slurry with the method; (B) performing 3D printing with the ceramic slurry to form a primary green body; (C) placing the primary green body in a freezer to undergo a refrigeration process, thereby causing crystallization of polyvinyl alcohol; and (D) thawing the frozen primary green body to form a plastic green body with gel structure.

### BACKGROUND OF THE INVENTION

### 1. Field of the Invention

The present disclosure relates to a method of preparation of a ceramic slurry for use in 3D printing, and in particular to a method of preparation of a ceramic slurry comprising Yttria-stabilized zirconia (YSZ) powder. The present disclosure relates to a method of preparation of a ceramic product from the ceramic slurry.

### 2. Description of the Related Art

3D printing, also known as additive manufacturing, is increasingly embraced by the industrial sector and academic circles. 3D printing is a method of creating a three-dimensional object layer-by-layer using a computer created design. 3D printing is not only capable of manufacturing complicated objects otherwise impossible to conventional manufacturing processes, but is also best suited for customization. Existing major materials for use in 3D printing include polymers and metals. By contrast, ceramic materials are rarely used in 3D printing, because they need to undergo a difficult heat treatment process. However, ceramic materials do have advantageous features, such as highly tolerant to heat, highly tolerant to acids and alkalis, and mechanically strong; thus, they have wide applications in various fields. For instance, conventional wafer fabrication requires switching wafers being manufactured from one process to another, using mechanical arms. Mechanical arm jigs are best made of ceramic materials, as the processes are carried out in high-temperature, corrosive environments. However, conventional ceramic preparation requires molds and entails cutting, not to mention that it necessitates testing different jigs at the cost of time efficiency and cost efficiency. In this regard, 3D printing offers a solution to the aforesaid problem, as ceramic jigs can be tested for different functions quickly, easily and cost efficiently.

Conventional 3D printing processes for ceramic materials rely on techniques, such as binder jetting, stereolithography, and direct ink writing. In binder jetting, the nozzle of a printer sprays an adhesive to a cylinder that contains ceramic powder, outlining a three-dimensional object gradually as a result of the movement of the nozzle and the cylinder. Finally, a green body thus bound is taken out of the powder to undergo sintering. In stereolithography, ceramic powder or a ceramic precursor is spread in an adhesive comprising polymer monomers, and then the printer casts light on the ink to control light patterns in each layer structure to thereby polymerize the polymer monomers in accordance with a specified shape, so as to obtain a green body. Advantages of stereolithography are small layer thickness and high fineness. However, a lithography process requires a high-ratio polymer monomer adhesive which is volatile during a subsequent sintering process of the ceramic material, thereby causing a sample to crack. As a result, few ceramic materials can undergo printing in this way and thus have narrow material-related applications. In direct ink writing, ceramic powder-based slurry undergoes extrusion with the nozzle and 3D printing to form a green body with a specified three-dimensional shape. Compared with the aforesaid two techniques, direct ink writing is not only readily applicable to different ceramic materials but is also capable of performing 3D printing on two or more materials simultaneously. Drawbacks of direct ink writing include low fineness and the susceptibility of the nozzle to clogging. In this regard, the major challenging issue with direct ink writing is about how to control the degree of dispersion of the ceramic powder in the ceramic slurry and the rheological behavior of the ceramic slurry.

Regarding direct ink writing, ratios of a ceramic slurry prepared to its respective constituents are crucial to the printing performance. To prevent the sintered finished product from contracting and cracking, the proportion of solid powder in the slurry has to be high, i.e., at least 30-50 vol %, in the presence of a small amount of adhesive. The high proportion of solid powder in the slurry requires an appropriate disperser, such as polybasic acid and polymeric electrolyte, to augment the acting force of electric charges on the surfaces of particles, thereby reducing aggregation and sedimentation between the particles. In addition, the high-concentration slurry must manifest appropriate rheological behavior in order to undergo printing; the slurry usually has to demonstrate a viscous, resilient feature for shear thinning, and its viscosity has to decrease as shear speed increases. Thus, in a high shear speed environment of direct ink writing, ink extrusion and resultant formation takes place at a low pressure. Furthermore, the slurry also has to have high storage modulus (G′) and high yield stress, such that the extruded liquid ink not only quickly restores its solid-state resilient behavior substantially but also maintains its structure without collapsing under gravity.

### BRIEF SUMMARY OF THE INVENTION

An objective of the present disclosure is to provide a method of preparation of a ceramic slurry adapted for use in 3D printing, produced by direct ink writing and subsequently adapted to be easily made into different shapes. The technique involves gelating a printing sample with crystals produced as a result of refrigeration of polyvinyl alcohol (PVA), to solve problems as follows: ruptures which happen during a drying process and a sintering process; and structurally complicated objects require that copious amounts of support materials must be simultaneously produced by 3D printing in order to ensure the formation of structures and the ease of printing. This technique is applied to the 3D printing of ceramic materials.

To achieve at least the above objective, the present disclosure provides a method of preparation of a ceramic slurry for use in 3D printing, comprising the steps of:
(A) providing a plasticizer and a disperser and mixing the plasticizer and the disperser evenly;
(B) mixing the mixture obtained in step (A) with an adhesive, wherein the adhesive is polyvinyl alcohol (PVA); and
(C) adding a Yttria-stabilized zirconia (YSZ) powder to the mixture obtained in step (B) to produce, by sufficient blending and deaerating, the ceramic slurry for use in 3D printing.

Regarding the method, the plasticizer is polyethylene glycol (PEG-400).

Regarding the method, the disperser is a mixture of citric acid and sodium hydroxide.

Regarding the method, molecular weight of the polyvinyl alcohol (PVA) ranges from 88,000 to 97,000.

Regarding the method, a ratio of weight of the Yttria-stabilized zirconia (YSZ) powder to weight of the plasticizer ranges from 1:0.05 to 1:0.2.

Regarding the method, a ratio of weight of the Yttria-stabilized zirconia (YSZ) powder to weight of the disperser ranges from 1:0.01 to 1:0.05.

Regarding the method, a ratio of weight of the Yttria-stabilized zirconia (YSZ) powder to weight of the adhesive ranges from 1:0.05 to 1:0.2.

To solve the aforesaid problem, the present disclosure provides a method of preparation of a ceramic product, comprising the steps of:
(A) preparing a ceramic slurry with the method;
(B) performing 3D printing with the ceramic slurry to form a primary green body;
(C) placing the primary green body in a freezer to undergo a refrigeration process, thereby causing crystallization of polyvinyl alcohol (PVA); and
(D) thawing the frozen primary green body to form a plastic green body with gel structure.

Regarding the method, the refrigeration process takes place at 0 to −40° C.

Regarding the method, the refrigeration in step (C) lasts two hours, and the thawing in step (D) lasts half an hour.

The method further comprises the step of:
(E) placing the plastic green body in a muffle furnace filled with argon gas, then raising temperature in the muffle furnace at a speed of 1° C./min to 600° C. and keeping the 600° C. for two hours, and finally raising the temperature in the muffle furnace to 1450° C. and keeping the 1450° C. for two hours, so as to form a ceramic blank.

The method further comprises the step of:
(F) placing the ceramic blank in the muffle furnace again to bake the ceramic blank at 600° C. for two hours, so as to form a ceramic material free of residual carbon.

The present disclosure uses polyvinyl alcohol (PVA) as an adhesive and involves performing 3D printing with a ceramic slurry to form a primary green body, allowing the primary green body to undergo a refrigeration process and a thawing process, and causing crystallization of polyvinyl alcohol (PVA) in an aqueous dispersant solution. The crystal enhances physical cross-linking and thereby formation of a gel-like green body to not only achieve high structural strength but also preclude ruptures of the green body during a subsequent drying process and sintering process. Moreover, shapes can be changed under an external force to attain complicated structures. The present disclosure overcomes the drawbacks of the prior art, that is, a conventional ceramic green body produced by 3D printing is of low mechanical strength and thus is likely to crack during a drying process and a sintering process, such that structurally complicated objects require the simultaneous printing of a large amount of support materials in order to ensure the formation of the structures and the ease of printing. The use of non-toxic aqueous slurry achieves high solid content, high green body strength, 3D printing and subsequent plasticity of samples, thereby facilitating the customization of structurally complicated industrial samples.

According to the present disclosure, the method of preparation of a ceramic product can gelate a sample to be printed with the crystal produced as a result of the refrigeration of polyvinyl alcohol (PVA) to achieve two advantages as follows:

(1) Enhance green body structural strength: to enhance green body structural strength, a conventional ceramic green body has to increase the amount of organic matters in use and decrease ceramic solid content. The green body prepared according to the present disclosure has high solid content and structural strength and diminishes the contraction-induced cracks of the sample during the drying process of the green body.

(2) Subsequent plasticization of the green body: copious amounts of support materials must be produced by 3D printing in order to ensure the formation of structures and the ease of printing. The green body prepared according to the present disclosure manifests high structural strength and high ductility can be reshaped in a subsequent process to the reduce the required amount of support materials and form complicated structures.

### BRIEF DESCRIPTION OF THE DRAWINGS

FIG. 1 is a schematic view of the process flow of a method of preparation of a ceramic slurry for use in 3D printing according to embodiment 1.

FIG. 2 is a schematic view of the process flow of a method of preparation of a ceramic product according to embodiment 2.

FIG. 3 is a schematic view of the method of preparation of a ceramic product according to embodiment 2.

FIG. 4A is a graph of Zeta potential versus pH value of Yttria-stabilized zirconia (YSZ) powder.

FIG. 4B is a graph of particle diameter distribution of Yttria-stabilized zirconia (YSZ) powder at different pH values.

FIG. 5A is a graph of viscosity versus shear rate of Yttria-stabilized zirconia (YSZ) slurry with three different solid content levels, i.e., 30, 35 and 37.5 vol %.

FIG. 5B is a graph of storage modulus versus loss modulus of Yttria-stabilized zirconia (YSZ) slurry with three different solid content levels, i.e., 30, 35 and 37.5 vol %.

FIG. 6A is a picture taken of the result of 3D printing carried out with the method of preparation of a ceramic product according to embodiment 2.

FIG. 6B is a picture taken of the result of 3D printing carried out with the method of preparation of a ceramic product according to embodiment 2.

FIG. 7 is a picture taken of a plastic green body characterized by a gel structure and produced with the method of preparation of a ceramic product according to embodiment 2, showing the deformation of the plastic green body under an external force.

FIG. 8 shows SEM images of a Yttria-stabilized zirconia (YSZ) semi-finished product produced by carrying out a deaerating process at 600° C.

FIG. 9 shows SEM images of a mechanical arm finished product which has been sintered at 1450° C.

FIG. 10A is a bar chart of the result of a test of bending resistance strength of a Yttria-stabilized zirconia (YSZ) sintered finished product.

FIG. 10B is s a bar chart of the result of a test of the density of a Yttria-stabilized zirconia (YSZ) sintered finished product.

### DETAILED DESCRIPTION OF THE INVENTION

To facilitate understanding of the object, characteristics and effects of this present disclosure, embodiments together with the attached drawings for the detailed description of the present disclosure are provided.

### Embodiment 1

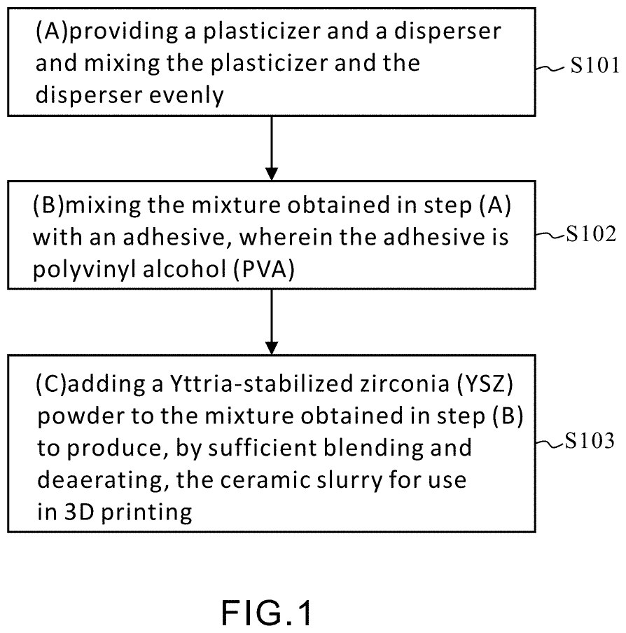

FIG. 1 is a schematic view of the process flow of a method of preparation of a ceramic slurry for use in 3D printing according to embodiment 1. In embodiment 1 illustrated with FIG. 1, the method of preparation of a ceramic slurry for use in 3D printing comprises the steps of: step (A) S101: providing a plasticizer and a disperser and mixing the plasticizer and the disperser evenly; step (B) S102: mixing the mixture obtained in step (A) with an adhesive, wherein the adhesive is polyvinyl alcohol (PVA); and step (C) S103: adding a Yttria-stabilized zirconia (YSZ) powder to the mixture obtained in step (B) to produce, by sufficient blending and deaerating, the ceramic slurry for use in 3D printing.

In embodiment 1, polyvinyl alcohol (PVA) functions as an adhesive in the ceramic slurry, as PVA is a water-soluble polymer. In addition to functioning as an adhesive, PVA is for use in preparing a water-soluble gel of high structural strength. Crystallization of PVA polymer is promoted by refrigeration of PVA aqueous solution. The crystal will not vanish even if temperature goes back to room temperature. Thus, the point of PVA crystallization functions as the point of polymer cross-linking to form water-soluble gel. Given the characteristics of PVA, a ceramic green body for use in 3D printing and ensuing deformation is formed with a simple formula.

In embodiment 1, Zeta potential of Yttria-stabilized zirconia (YSZ) ceramic powder at different pH values and different disperser concentrations is measured to evaluate the magnitude of the electric charges on the surfaces of the ceramic powder and the capability of the disperser to alter powder surface electric charges. With the result of the measurement of Zeta potential, PEG-400 plasticizer and pH-adjusted citric acid/sodium hydroxide disperser are mixed evenly and then introduced into a flask (the flask contains a PVA adhesive) so as to be mixed evenly therein. Then, Yttria-stabilized zirconia (YSZ) powder is added to the mixture and then blended and deaerating with a planetary revolution/rotation mixer, so as to prepare a slurry for use in 3D printing.

### Embodiment 2

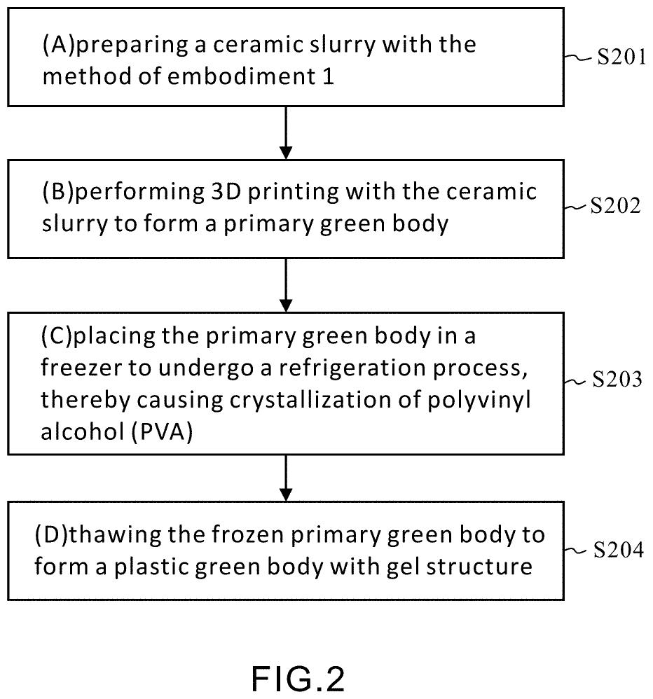

FIG. 2 is a schematic view of the process flow of a method of preparation of a ceramic product according to embodiment 2. In embodiment 2 illustrated with FIG. 2, the method of preparation of a ceramic product comprises the steps of: step (A) S201: preparing a ceramic slurry with the method of embodiment 1; step (B) S202: performing 3D printing with the ceramic slurry to form a primary green body; step (C) S203: placing the primary green body in a freezer to undergo a refrigeration process, thereby causing crystallization of polyvinyl alcohol (PVA); and step (D) S204: thawing the frozen primary green body to form a plastic green body with gel structure.

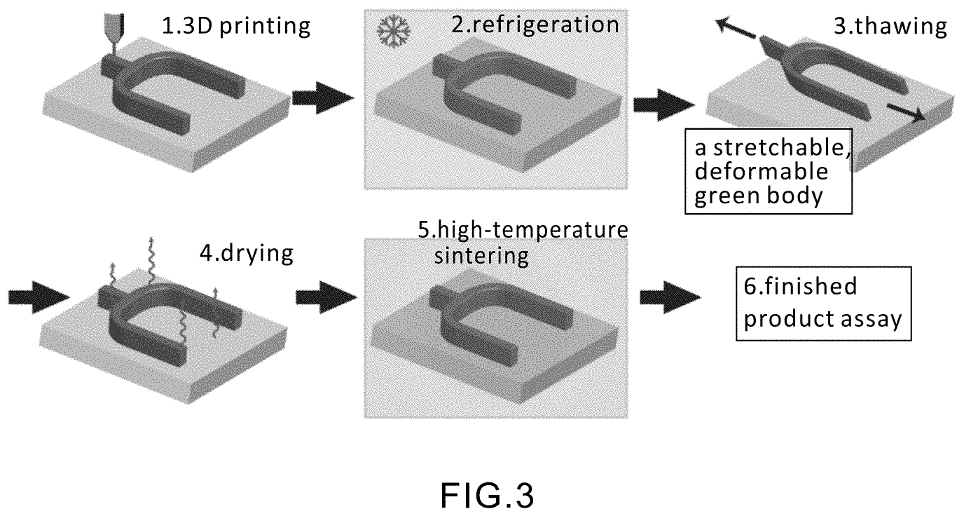

FIG. 3 is a schematic view of the method of preparation of a ceramic product according to embodiment 2. A ceramic slurry is prepared with the method of embodiment 1. Then, 3D printing is carried out with the ceramic slurry to form a primary green body. The primary green body is placed in a freezer at −20° C. for hours and thus gets frozen therein to cause crystallization of PVA. Then, the frozen primary green body is allowed to thaw. With the PVA having a gel structure, the green body not only manifests high structural strength but can also been shaped as needed under an external force. After being dried at room temperature to remove its redundant water content, the green body is placed in a muffle furnace to undergo a sintering process. In the muffle furnace, the green body is heated up to 600° C. and stays at this temperature for two hours to remove organic matters from the green body; then, the green body is heated up to 1450° C. to undergo sintering for hours.

Referring to FIG. 3, the method of preparation of a ceramic product in embodiment 2 further comprises: step (E): placing the plastic green body in a muffle furnace filled with argon gas, then raising temperature in the muffle furnace at a speed of 1° C./min to 600° C. and keeping the 600° C. for two hours, and finally raising the temperature in the muffle furnace to 1450° C. and keeping the 1450° C. for two hours, so as to form a ceramic blank. However, the present disclosure is not limited thereto.

In a preferred embodiment, the method of preparation of a ceramic product further: step (F): placing the ceramic blank in the muffle furnace again to bake the ceramic blank at 600° C. for two hours, so as to form a ceramic material free of residual carbon. However, the present disclosure is not limited thereto.

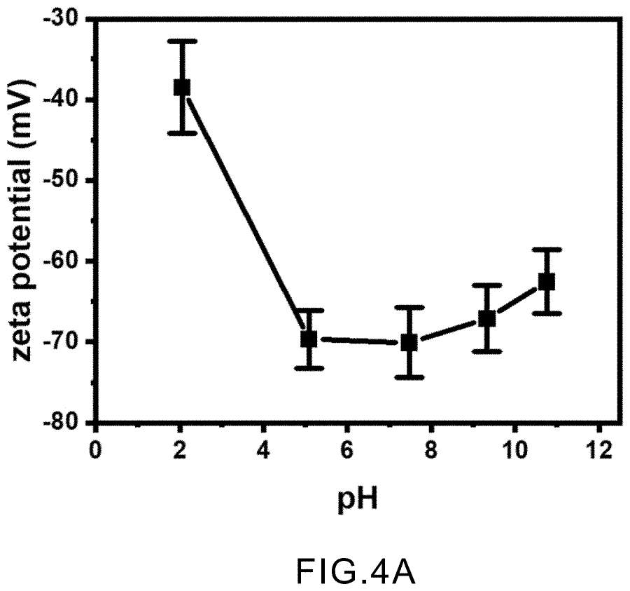

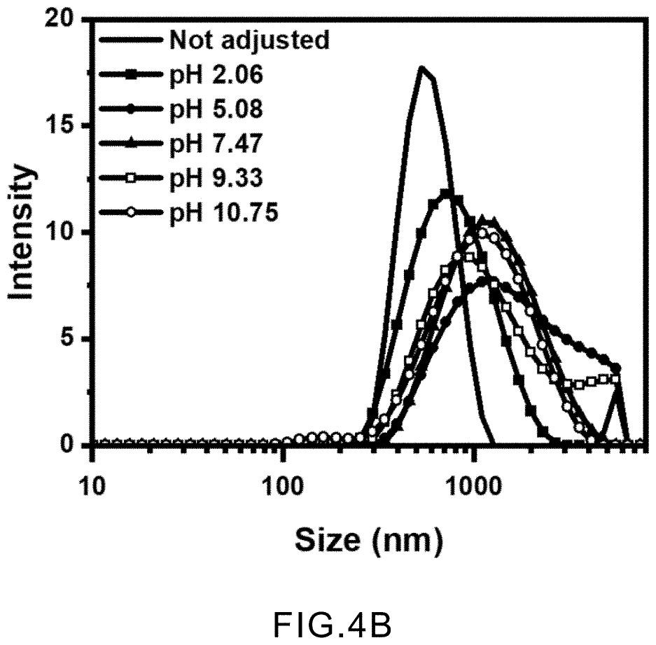

FIG. 4A is a graph of Zeta potential versus pH value of Yttria-stabilized zirconia (YSZ) powder. FIG. 4B is a graph of particle diameter distribution of Yttria-stabilized zirconia (YSZ) powder at different pH values. FIG. 4A shows that Zeta potential stays in the narrow range from −60 to −70 mV when pH value is above 5, implying the following: the negative range of potential is sufficient to prevent Yttria-stabilized zirconia (YSZ) powder from aggregating (because the powder particles repel each other under Coulomb force); with citric acid functioning as a disperser, the powder spreads in the water more uniformly; and the average powder particle diameter and distribution of Yttria-stabilized zirconia (YSZ) at different pH values in the presence of the disperser is larger and wider, respectively, than in the absence of any disperser. The deposition of Yttria-stabilized zirconia (YSZ) powder occurs in the course of the particle diameter measurement process performed thereon, for a density-related reason; this, coupled with the fact that the particle diameter measurement process takes 20 minutes or so, leads to unexpected outcome. However, the result of Zeta potential proves that the mere condition of pH 5 is sufficient to adsorb citric acid to the surfaces of Yttria-stabilized zirconia (YSZ) powder particles.

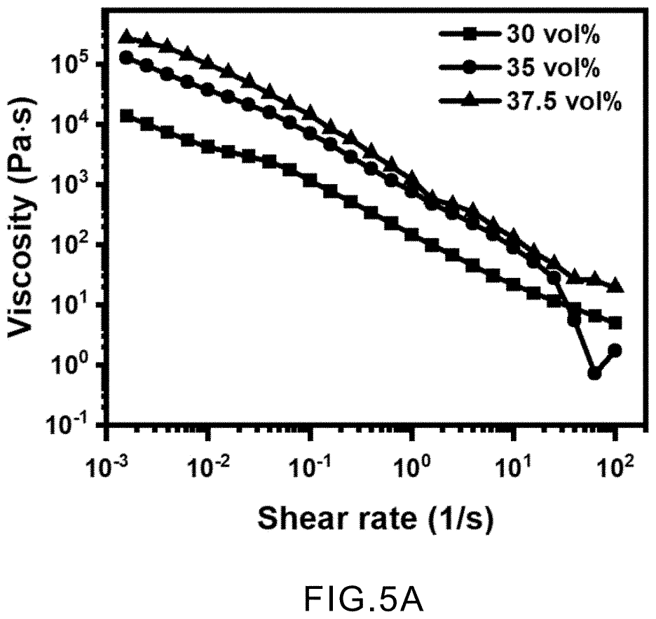

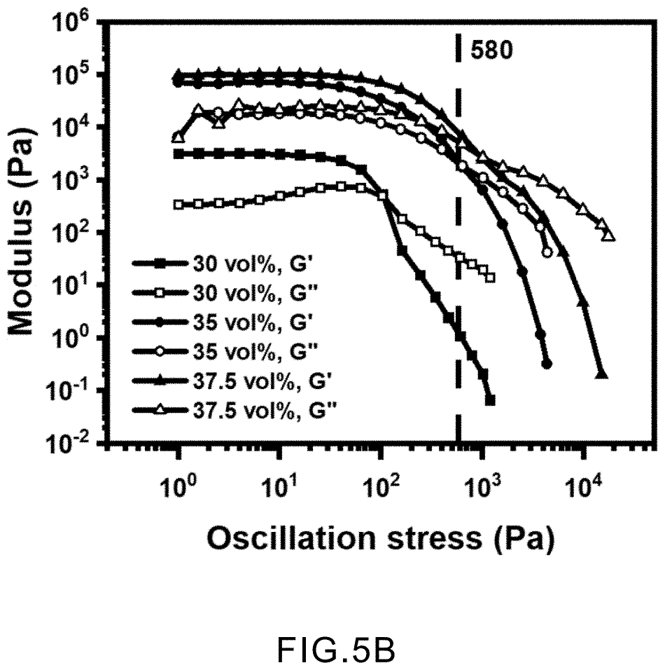

FIG. 5A is a graph of viscosity versus shear rate of Yttria-stabilized zirconia (YSZ) slurry with three different solid content levels, i.e., 30, 35 and 37.5 vol %. FIG. 5B is a graph of storage modulus versus loss modulus of Yttria-stabilized zirconia (YSZ) slurry with three different solid content levels, i.e., 30, 35 and 37.5 vol %. FIG. 5A shows that all the three viscosity levels of the slurry decrease linearly with the increase in shear speed, thereby satisfying the shear thinning feature required for 3D printing. FIG. 5B shows that the yield stress of the 30 vol % Yttria-stabilized zirconia (YSZ) slurry is around 100, thereby causing the semi-finished product to tumble or tilt. The 37.5 vol % slurry has desirable yield stress value and the highest viscosity level, but the high viscosity level disadvantageously causes difficulty in pump extrusion and renders the pump's extrusion speed unstable. After giving considerations to the aforesaid factors, the inventor of the present disclosure chose to perform 3D printing with 35 vol % slurry at yield stress of around 580 Pa.

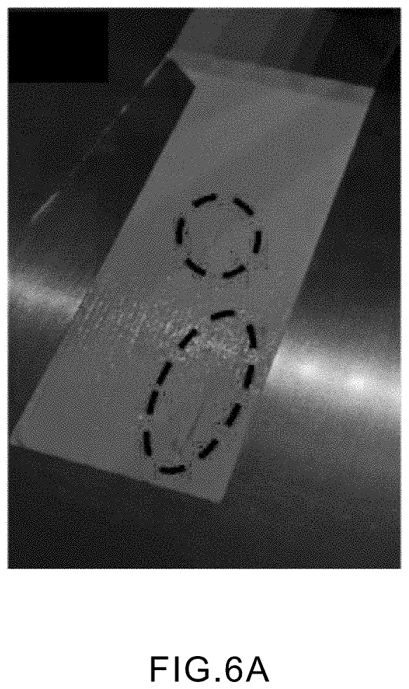

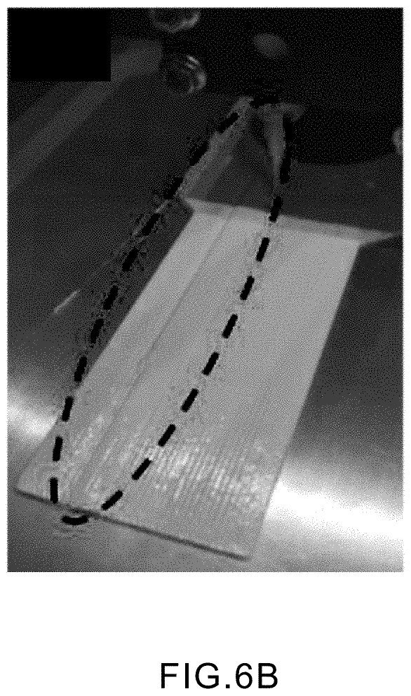

The printing is carried out with 35 vol % Yttria-stabilized zirconia (YSZ) powder solid content, 0.5 wt % citric acid used as a disperser, 2.5 wt % polyvinyl alcohol (PVA) used as an adhesive and 2.5 wt % PEG-400 used as a plasticizer. Since the slurry has a problem with water evaporation and intense post-sintering contraction, the printing process is carried out at 35 mm/s, with an extrusion ratio of 60% and a sample filling ratio of 85%. As shown in FIG. 6A and FIG. 6B, when carried out at 35 mm/s, the printing process is efficient in sorting lines neatly and stacking layers, and in consequence no conspicuous printing defects are observed. The resultant slurry has appropriate storage modulus and yield stress and can be printed by direct ink writing.

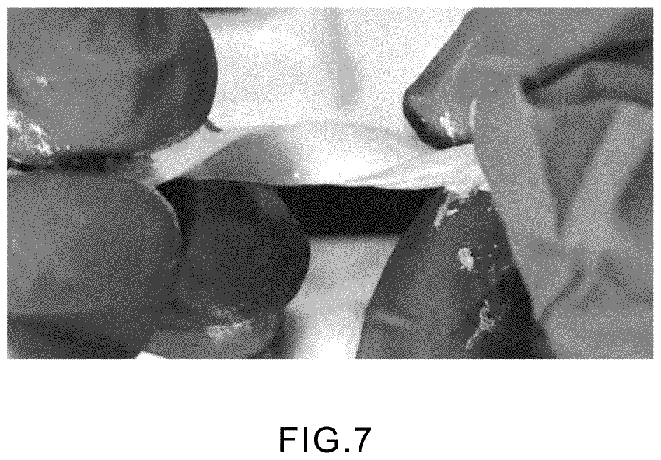

Owing to a difference in drying speed, the finished product thus printed warps and cracks when exposed to air. Samples are placed in a refrigerator at −20° C. to not only freeze its water content but also cause crystallization of PVA. Then, the samples thaw. Thus, the green body demonstrates enhanced plasticity in its entirety and is able to deform under an external force, as shown in FIG. 7. Furthermore, the finished product is unlikely to warp under gravity, because it deforms when squeezed by hand.

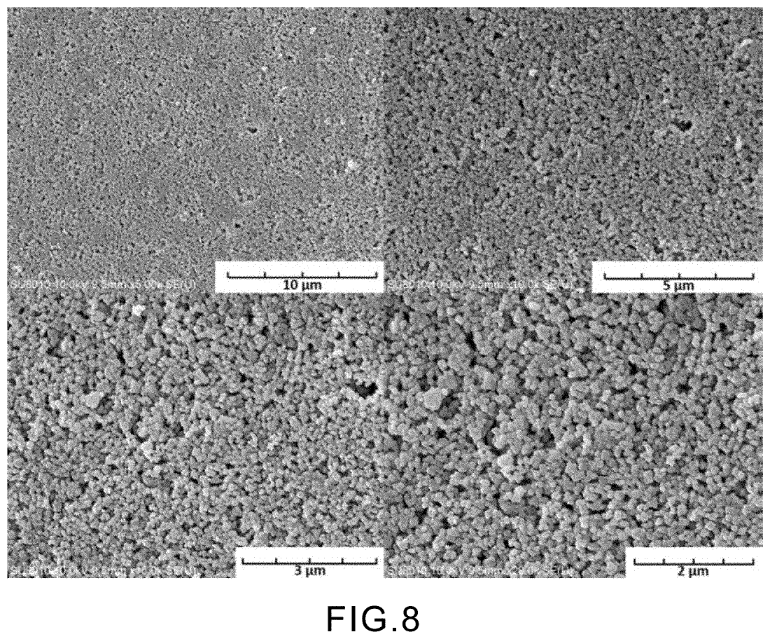

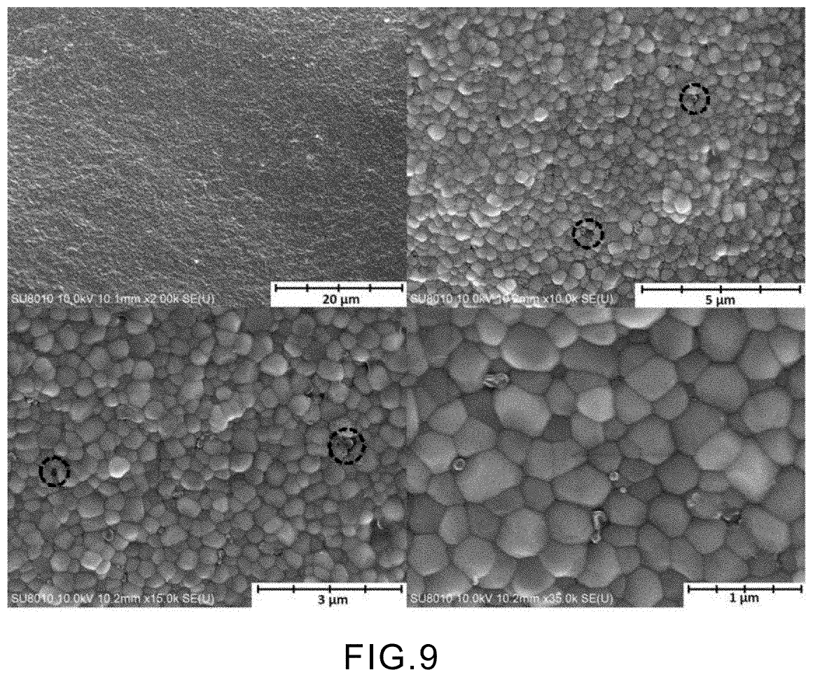

FIG. 8 shows SEM images of a Yttria-stabilized zirconia (YSZ) semi-finished product produced by carrying out a deaerating process at 600° C. FIG. 9 shows SEM images of a mechanical arm finished product which has been sintered at 1450° C. Experimental results indicate variations in the form of the Yttria-stabilized zirconia (YSZ) powder. Referring to FIG. 8, prior to the deaerating process, the Yttria-stabilized zirconia (YSZ) powder has not yet been fully compacted but contains conspicuous gaps between the powder particles. As shown in FIG. 9, the powder particles are mostly melted and bonded together. The SEM images show some defective pores (in red circles). The pores either originate from residual bubbles during the printing process or result from asymmetric contractions of the sample during the drying process and sintering process. Thus, the aforesaid defects may be diminished by prolonging the sintering process.

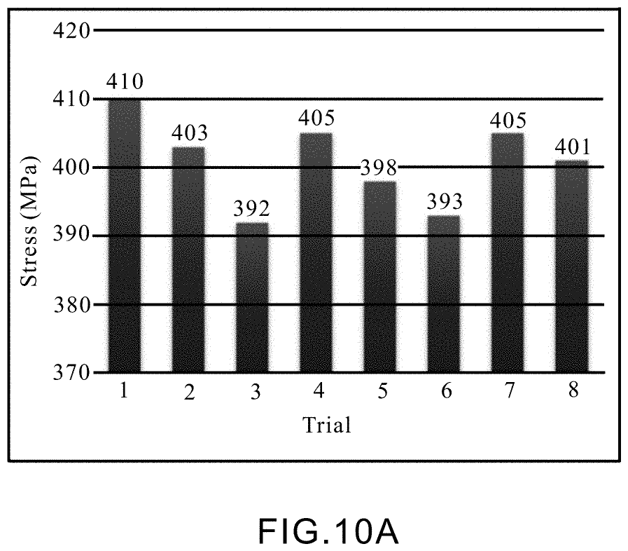

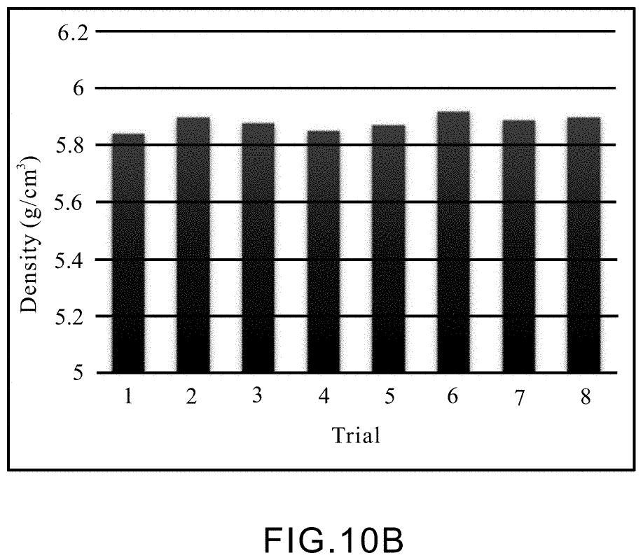

The sintered sample is tested in accordance with ASTM C 1161 standard to evaluate its mechanical strength. The Yttria-stabilized zirconia (YSZ) sintered finished product is tested in a three-point bending resistance mode to evaluate its bending resistance strength. The test results are shown in FIG. 10A, indicating that the Yttria-stabilized zirconia (YSZ) sintered finished product has an average bending resistance strength of around 400 MPa and a minimal bending resistance strength of 392 MPa, implying that the Yttria-stabilized zirconia (YSZ) sintered finished product mostly has a sufficiently high bending resistance strength, and confirming that the Yttria-stabilized zirconia (YSZ) sample is satisfactorily sintered.

The density of the Yttria-stabilized zirconia (YSZ) sintered finished product is evaluated by Archimedean principle. The evaluation result is shown in FIG. 10B, indicating that zirconia has a theoretical density of 6.00 g/cm3 and an average density of 5.88 g/cm3 (i.e., 97.93% of the theoretical density), implying that the density of the Yttria-stabilized zirconia (YSZ) sample meets the predetermined standard, and confirming that the sintering process can be smoothly carried out at 1450° C. for two hours. This result is consistent with the SEM images of the Yttria-stabilized zirconia (YSZ) sample. The tight arrangement of and few gaps between the Yttria-stabilized zirconia (YSZ) crystals in the finished product confirm that the Yttria-stabilized zirconia (YSZ) slurry has been sintered.

While the present disclosure has been described by means of specific embodiments, numerous modifications and variations could be made thereto by those skilled in the art without departing from the scope and spirit of the present disclosure set forth in the claims.

What is claimed is:

1. A method of preparation of a ceramic slurry for use in 3D printing, comprising the steps of:
(A) providing a plasticizer and a disperser and mixing the plasticizer and the disperser evenly;
(B) mixing the mixture obtained in step (A) with an adhesive, wherein the adhesive is polyvinyl alcohol (PVA); and
(C) adding a Yttria-stabilized zirconia (YSZ) powder to the mixture obtained in step (B) to produce, by sufficient blending and deaerating, the ceramic slurry for use in 3D printing.

2. The method of claim 1, wherein the plasticizer is polyethylene glycol (PEG-400).

3. The method of claim 1, wherein the disperser is a mixture of citric acid and sodium hydroxide.

4. The method of claim 1, wherein molecular weight of the polyvinyl alcohol (PVA) ranges from 88,000 to 97,000.

5. The method of claim 1, wherein a ratio of weight of the Yttria-stabilized zirconia (YSZ) powder to weight of the plasticizer ranges from 1:0.05 to 1:0.2.

6. The method of claim 1, wherein a ratio of weight of the Yttria-stabilized zirconia (YSZ) powder to weight of the disperser ranges from 1:0.01 to 1:0.05.

7. The method of claim 1, wherein a ratio of weight of the Yttria-stabilized zirconia (YSZ) powder to weight of the adhesive ranges from 1:0.05 to 1:0.2.

8. A method of preparation of a ceramic product, comprising the steps of:
(A) preparing a ceramic slurry with the method of claim 1;
(B) performing 3D printing with the ceramic slurry to form a primary green body;
(C) placing the primary green body in a freezer to undergo a refrigeration process, thereby causing crystallization of polyvinyl alcohol (PVA); and
(D) thawing the frozen primary green body to form a plastic green body with gel structure.

9. The method of claim 8, wherein the refrigeration process takes place at 0 to −40° C.

10. The method of claim 8, wherein the refrigeration in step (C) lasts two hours, and the thawing in step (D) lasts half an hour.

11. The method of claim 8, further comprising the step of:
(E) placing the plastic green body in a muffle furnace filled with argon gas, then raising temperature in the muffle furnace at a speed of 1° C./min to 600° C. and keeping the 600° C. for two hours, and finally raising the temperature in the muffle furnace to 1450° C. and keeping the 1450° C. for two hours, so as to form a ceramic blank.

12. The method of claim 11, further comprising the step of:
(F) placing the ceramic blank in the muffle furnace again to bake the ceramic blank at 600° C. for two hours, so as to form a ceramic material free of residual carbon.
